(19) United States
(12) Patent Application Publication
(10) Pub. No.: US 2006/0167187 A1
(43) Pub. Date: Jul. 27, 2006

(54) Method for the anionic polymerisation of high-impact polystyrene

(75) Inventors: Philippe Desbois, Maikammer (DE); Uwe Klee, Lambsheim (DE)

Correspondence Address: CONNOLLY BOVE LODGE & HUTZ LLP, SUITE 800, 1990 M STREET NW, WASHINGTON, DC, 20036-3425, US

(73) Assignee: BASF AKTIENGESELLSCHAFT, Ludwigshafen (DE)

(21) Appl. No.: 10/533,092

(22) PCT Filed: Oct. 21, 2003
(86) PCT No.: PCT/EP03/11623

§ 371 Date: Apr. 28, 2005

(30) Foreign Application Priority Data
Oct. 28, 2002 (DE) 102502803

(51) Int. Cl. C08F 297/02

(52) U.S. Cl. 525/242

(57) ABSTRACT

Anionic polymerization process for preparing impact-modified polystyrene, by 1) preparing a rubber solution from diene monomers or from diene monomers and styrene monomers by anionic solution polymerization, using an organyllithium compound, 2) adding sufficient organylaluminum compound to give an Al/Li molar ratio >1 (or in the case of dialkylaluminum phenolates >0.5), 3) adding styrene monomer, and 4) adding sufficient organyllithium compound, or organyllithium compound and organylaluminum compound, to make the Al/Li molar ratio <1 (or in the case of dialkylaluminum phenolates <0.5) ist, and polymerizing the mixture.

The invention relates to a process for preparing impact-modified polystyrene by anionic polymerization.

The invention further relates to the impact-modified polystyrene obtainable by the process, to the use of the impact-modified polystyrene for producing moldings, films, fibers, or foams, and also to the moldings, films, fibers, or foams made from the impact-modified polystyrene.

There are various polymerization processes known for preparing impact-modified polystyrene (HIPS, high impact polystyrene), proceeding in solution or in suspension, by a free-radical or anionic route, continuously or batchwise, see, for example Ullmanns Enzyklopadie der Technischen Chemie, Vol. A21, VCH Verlag Weinheim 1992, pp. 615-625. These processes prepare a rubber (e.g. polybutadiene or styrene-butadiene block copolymers), for example by an anionic or free-radical mechanism, and dissolve the same in monomeric styrene. The styrene is then polymerized, for example by a free-radical or anionic route. During the course of polystyrene formation, phase inversion takes place: the rubber phase has become dispersed in a polystyrene matrix.

Compared with the products obtained by a free-radical route, the impact-modified polystyrenes obtained by anionic polymerization have some advantages, including lower contents of residual monomers and of oligomers. When the free-radical polymerization route is used, the reaction proceeds by way of free radicals and use is made of, for example, peroxidic initiators, whereas the anionic polymerization proceeds by way of “living” carbanions and uses, for example, organyl compounds of alkali metals as initiators.

The anionic polymerization proceeds substantially more rapidly and leads to higher conversions than the free-radical polymerization. Due to the high reaction rate, temperature control of the exothermic reaction is difficult. This can be countered by using what are known as retarders (for example organyl compounds of Al, of Zn, or of Mg), which lower the reaction rate. During anionic rubber preparation, the rise in the viscosity of the reaction mixture is generally so fast that undesired “hot spots” form in the reactor due to poor mixing and, furthermore, handling of the rubber formed is difficult: it becomes impossible to convey the rubber by pumping. This viscosity problem may be avoided by diluting the reaction mixture with an inert solvent, but this gives the overall process poorer productivity and requires time-consuming and energy-intensive devolatilization of the final HIPS product to remove the solvent.

WO-A 01/10917 describes an anionic HIPS preparation process which begins by polymerizing a diene monomer dissolved in a vinylaromatic, by an anionic route using an alkyllithium initiator, to give a low-molecular-weight polydiene. A trialkylaluminum compound is then added in molar excess with respect to the alkyllithium compound, the mixture is diluted with further vinylaromatic, and the low-molecular-weight “living” polydiene chains are coupled, using a coupling agent, to give a high-molecular-weight polydiene. This solution of the polydiene in vinylaromatic can be further polymerized to give HIPS. A particular disadvantage of the process described is that the coupling reaction requires the use of relatively large amounts of expensive alkyllithium compound (one Li atom per living polydiene chain).

WO-A 98/07766 discloses a process for preparing impact-modified polystyrene by preparing a diene polymer in a first reaction zone by means of anionic solution polymerization, further polymerizing the mixture in a second reaction zone by an anionic or free-radical route until phase inversion occurs, with optional addition of terminator or coupling agent, vinylaromatic, and/or further initiator at this stage, and polymerizing the mixture to completion in a third zone with freshly added vinylaromatic. According to examples 15-18, a styrene-butadiene block copolymer rubber dissolved in styrene monomer is prepared from butadiene monomer and styrene monomer in a first reactor, using a premixed catalyst solution made from sec-butyllithium initiator and dibutylmagnesium retarder (Mg/Li molar ratio >1), and this is treated in a second reactor with chain terminator and with a premixed catalyst solution (constitution as above, Mg/Li molar ratio >1), or with sec-butyllithium alone, and polymerized to completion in a third reactor.

WO-A 99/40135 describes a process for preparing impact-modified polystyrene by using anionic polymerization to prepare a rubber solution from butadiene and styrene with addition of solvent, reacting the rubber solution with a terminator or coupling agent, diluting it with vinylaromatic, and finally polymerizing the mixture to completion to give the HIPS. The rubber solution is terminated by the coupling reaction or termination reaction. In examples 10 and 11, a styrene-butadiene block copolymer rubber prepared by an anionic route using sec-butyllithium, terminated using a coupling agent and dissolved in styrene is treated with further styrene and with a mixture of sec-butyllithium and triisobutylaluminum retarder, and the mixture is polymerized to completion to give the HIPS.

The two abovementioned processes use complicated apparatus and/or require the use of terminators or coupling agents during the synthesis of the rubber, thus complicating the preparation of the HIPS and making it more expensive.

It is an object of the present invention to eliminate the disadvantages described. In particular, an object was to provide a process for preparing impact-modified polystyrene by anionic polymerization with no need for concomitant use of coupling agents or terminators during the process to synthesize the rubber. A further object is to provide a process in which the rubber solution has higher solids content than in the processes of the prior art, thus improving the capacity of the process and simplifying solvent removal. These advantages should not be obtained at the cost of the thermal and mechanical properties of the HIPS.

We have found that this object is achieved by means of the process defined at the outset. It comprises
1) preparing a rubber solution from diene monomers, or from diene monomers and styrene monomers, by anionic polymerization, using an organyllithium compound as initiator, and with concomitant use of a solvent,
2) adding, to the resultant rubber solution, an organylaluminum compound, its amount being such that the aluminum/lithium molar ratio in the rubber solution is greater than 1 or, if the organylaluminum compound used comprises a dialkylaluminum phenolate, is greater than 0.5,
3) adding styrene monomer to the resultant solution, and
4) adding, to the resultant mixture, organyllithium compound, or organyllithium compound and organylaluminum compound, the amount being such that the aluminum/lithium molar ratio in the mixture is smaller than 1 or, if the organylaluminum compound used comprises a dialkylaluminum phenolate, is smaller than 0.5, and polymerizing the mixture anionically.

The invention also provides the impact-modified polystyrene obtainable by the process, the use of the impact-modified polystyrene to produce moldings, films, fibers, or foams, and also the moldings, films, fibers, or foams made from the impact-modified polystyrene.

Preferred embodiment of the process are given in the subclaims.

The process of the invention differs from the prior-art processes mentioned in that organylaluminum compounds are used as retarder instead of organylmagnesium compounds, in that there is no need to use terminators or coupling agents during the preparation of the rubber, in that defined and different Al/Li molar ratios are present in the individual stages 1)-4) of the process, and in that no concomitant use of retarders is needed during preparation of the rubber solution.

The individual stages 1)-4) of the process are described in more detail below.

Stage 1)

The first stage prepares a rubber solution from diene monomers, or from diene monomers and styrene monomers, by anionic polymerization, using an organyllithium compound as initiator and with concomitant use of a solvent.

Examples of diene monomers which may be used are 1,3-butadiene, 2,3-dimethylbutadiene, 1,3-pentadiene, 1,3-hexadiene, isoprene, and piperylene. Preference is given to 1,3-butadiene and isoprene, in particular 1,3-butadiene (referred to below by the abbreviated term butadiene).

The styrene monomers used may also comprise, besides or in a mixture with styrene, vinylaromatic monomers which have substitution on the aromatic ring and/or on the C=C double bond with C₁₋₂₀-hydrocarbon radicals. It is preferable to use styrene, a-methylstyrene, p-methylstyrene, ethylstyrene, tert-butylstyrene, vinyltoluene, 1,2-diphenylethylene, 1,1-diphenylethylene, or a mixture of these. Styrene is particularly preferably used.

The monomers and other starting materials used, e.g. solvents, advantageously have the typical purity required for the process, meaning that disruptive contaminants are removed directly prior to the polymerization in a manner known per se, examples of these being residual moisture, polar substances, and oxygen.

In addition to the styrene monomers and diene monomers, concomitant use may also be made of other comonomers. The proportion of the comonomers is preferably from 0 to 50% by weight, particularly preferably from 0 to 30% by weight, and in particular from 0 to 15% by weight, based on the total amount of the monomers used in stage 1).

Examples of suitable comonomers are acrylates, in particular C₁₋₁₂-alkyl acrylates, such as n-butyl acrylate or 2-ethylhexyl acrylate, and the corresponding methacrylates, in particular C₁₋₁₂-alkyl methacrylates, such as methyl methacrylate (MMA). The monomers mentioned under M1 to M10 in lines 5-50 of p. 3 of DE-A 196 33 626 are also suitable as comonomers. That specification is expressly incorporated herein by way of reference.

The diene monomer used preferably comprises butadiene, and the styrene monomer used preferably comprises styrene.

The rubbers—known per se—are prepared by anionic polymerization in a manner known per se.

The term organyl compounds is used below for the organometallic compounds of the elements mentioned which have at least one metal-carbon sigma bond, in particular the alkyl compounds or aryl compounds. Besides this, the organyl metal compounds may also contain hydrogen or halogen, or may contain organic radicals, such as alcoholates or phenolates, bonded by way of heteroatoms, on the metal. One way of obtaining the latter radicals is complete or partial hydrolysis, alcoholysis or aminolysis. It is also possible to use mixtures of various organyl metal compounds.

Organyllithium compounds are used as initiators for the anionic polymerization, examples being ethyl-, propyl-, isopropyl-, n-butyl-, sec-butyl-, tert-butyl-, phenyl-, diphenylhexyl-, hexamethylenedi-, butadienyl-, isoprenyl-, or polystyryllithium, or multifunctional organyllithium compounds, such as 1,4-dilithiobutane, 1,4-dilithio-2-butene, or 1,4-dilithiobenzene. It is preferable to use sec-butyllithium (s-Buli).

The amount of organyllithium compound needed depends on the desired molecular weight, on the nature and amount of the other organylmetal compounds used, and also on the polymerization temperature. It is generally in the range from 1 ppm(w) to 2% by weight, preferably from 100 ppm(w) to 1% by weight, in particular from 1 000 to 10 000 ppm(w), based on the total amount of monomers.

It is also possible to use various organyllithium compounds together.

The polymerization is carried out in the presence of a solvent (solution polymerization). The solvent is preferably inert under the polymerization conditions. Particularly suitable materials are aliphatic, isocyclic, or aromatic hydrocarbons, or hydrocarbon mixtures, for example benzene, toluene, ethylbenzene, xylene, cumene, pentane, heptane, octane, cyclohexane or methylcyclohexane. It is preferable to use solvents with a boiling point above 95° C. Toluene is particularly preferably used.

In one preferred embodiment, the preparation of the rubber solution (i.e. stage 1) of the process) makes no concomitant use of compounds which have a retarding action on the anionic polymerization. It is therefore preferable not to use any retarders (=additives which reduce polymerization rate) in stage 1).

This has the advantage of accelerating the synthesis of the rubber, i.e. that step of the process which generally determines the production capacity for the entire HIPS preparation process. This means that the synthesis of the rubber is no longer the capacity-determining HIPS-process bottleneck when the process of the invention is used.

If diene monomers alone are used to prepare the rubber, a homopolydiene rubber is obtained in stage 1). In this case preference is given to homopolybutadiene rubber, abbreviated to polybutadiene. The polybutadiene particularly preferably has a weight-average molar mass M_{w} of from 30 000 to 300 000, in particular from 50 000 to 250 000 g/mol, and particularly preferably from 60 000 to 200 000 g/mol. Mw is determined in a known manner, by gel permeation chromatography (GPC), using polybutadiene calibration standards, usually in tetrahydrofuran (THF) as solvent.

If, besides diene monomers, use is also made of styrene monomers as rubber monomers, the result is a diene-styrene monomer copolymer rubber. It is preferably a butadiene-styrene copolymer rubber. The butadiene units and styrene units here may have a random arrangement or—preferably—a block arrangement. The latter copolymers are usually termed styrene-butadiene block copolymers, and are preferred.

The rubber is therefore preferably one selected from polybutadiene and styrene-butadiene block copolymers.

The styrene-butadiene block copolymers may be linear S-B two-block copolymers, for example, or S-B-S or B-S-B three-block copolymers (S=styrene block, B=butadiene block), as are obtained by anionic polymerization in processes known per se. The block structure is substantially a result of initial sole anionic polymerization of styrene, producing a styrene block. Once the styrene monomers have been consumed, the monomer is changed by adding monomeric butadiene and polymerizing this anionically to give a butadiene block (termed sequential polymerization). The resultant S-B two-block polymer may be polymerized to give an S-B-S three-block polymer via another change of monomer for styrene, if desired. The same principle applies to B-S-B three-block copolymers.

In the case of the three-block copolymers, the two styrene blocks may have the same size (same molecular weight, i.e. symmetrical S₁-B-S₁ structure) or may have a different size (different molecular weight, i.e. asymmetric S₁-B-S₂ structure). The same principle applies for the two butadiene blocks of the B-S-B block copolymers. Other block sequences S-S-B, or S₁-S₂-B, or S-B-B, or S-B₁-B₂ are, of course, also possible. The indices above represent the block sizes (block lengths or molecular weights). The block sizes depend on the amounts of monomers used and the polymerization conditions, for example.

There may also be B/S blocks in place of the “soft” elastomeric butadiene blocks B or in addition to the blocks B. The B/S blocks are likewise soft, and contain butadiene and styrene, for example with random distribution or in the form of a tapered structure (tapered=gradient from styrene-rich to styrene-poor or vice versa). If the block copolymer contains two or more B/S blocks, the absolute amounts, and the relative proportions, of styrene and butadiene in each of the B/S blocks may be identical or different, giving different blocks (B/S)₁, (B/S)₂, etc.). The B/S blocks are also termed “mixed” blocks—irrespective of whether they have random structure, tapered structure, or any other type of structure.

Four-block and polyblock copolymers are also suitable styrene-butadiene block copolymers.

The block copolymers mentioned may have a linear structure (described above), or else have branched or star structures. Branched block copolymers are obtained in a known manner, e.g. by graft reactions of polymeric “branches” onto a main polymer chain.

An example of a method for obtaining star block copolymers is reaction of the living anionic chain ends with an at least bifunctional coupling agent. These coupling agents are described by way of example in US-A 3 985 830, 3 280 084, 3 637 554 and 4 091 053. Preference is given to epoxidized glycerides (e.g. epoxidized linseed oil or soy oil), silicon halides, such as SiCI₄, or else divinylbenzene, or polyfunctional aldehydes, ketones, esters, anhydrides or epoxides. Carbonates, such as diethyl carbonate or ethylene carbonate (1,3-dioxolan-2-one) are likewise preferred. Other suitable compounds specifically for dimerization are dichlorodialkylsilanes, dialdehydes, such as terephthalaldehyde and esters, such as ethyl formate or ethyl acetate.

Symmetrical or asymmetrical star structures can be prepared by coupling identical or different polymer chains, meaning that each of the arms of the star may be identical or different, and may in particular contain different blocks S, B, B/S, or different block sequences. Other details concerning star block copolymers are found by way of example in WO-A 00/58380.

The residual butadiene content of the rubber used (e.g. styrene-butadiene block copolymer or homopolybutadiene) should be below 200 ppm, preferably below 50 ppm, in particular below 5 ppm.

The styrene-butadiene block copolymer rubber preferably contains at least one butadiene block with a weight-average molar mass M_{w} of from 50 000 to 250 000 g/mol, preferably from 140 000 to 180 000 g/mol, for example from about 160 000 to 165 000 g/mol.

In another embodiment, likewise preferred, the butadiene content of the rubber is from 70 to 100% by weight, preferably from 75 to 95% by weight, and particularly preferably from 80 to 90% by weight, based on the rubber without solvent.

In one preferred embodiment, the solids content (SC) of the rubber solution obtained in stage 1) of the process is from 20 to 40% by weight, in particular from 25 to 40% by weight, and particularly preferably from 28 to 37% by weight, for example from about 30 to 35% by weight.

Stage 2)

The second stage of the process of the invention involves adding, to the rubber solution obtained in stage 1), an organylaluminum compound, its amount being such that the aluminum/lithium molar ratio in the rubber solution is greater than one, meaning that the Al/Li molar ratio is >1 in the resultant solution after addition of the organylaluminum compound.

If the organylaluminum compound used comprises a dialkylaluminum phenolate, its amount added is such that the Al/Li molar ratio in the rubber solution is greater than 0.5, meaning that the Al/Li molar ratio is >0.5 in the resultant solution after addition of the dialkylaluminum phenolate.

The amount of organylaluminum compound added is preferably such that the Al/Li molar ratio is from 1.01 to 10, particularly preferably from 1.05 to 2. Even a small molar excess of aluminum is therefore sufficient.

If the organylaluminum compound used comprises a dialkylaluminum phenolate, its amount added is preferably such that the Al/Li molar ratio is from 0.51 to 10.

It is likely that the action of the organylaluminum compound at an Al/Li molar ratio >1 is that of a “stopper” for the anionic polymerization reaction initiated by the organyllithium compound: it appears that the addition of the organylaluminum compound in stage 2) to give an Al/Li molar ratio >1 stops the anionic polymerization started in stage 1). However, it appears that the addition of the organylaluminum compound does not terminate the living polymer chains, but that these retain living character. However, the molar excess of the organylaluminum retarder compound lowers the reaction rate of the polymerization to zero. It therefore appears that the addition of the organylaluminum compound in stage 2) merely “freezes” the polymerization reaction—with polymer chains which are inactive but retain living character - rather than ending the polymerization.

The principle of the above paragraph also applies for dialkylaluminum phenolates at an Al/Li molar ratio of >0.5.

Organylaluminum compounds which may be used are those of the formula R₃Al, the radicals R being, independently of one another, hydrogen, halogen, C₁-C₂₀-alkyl, or C₆-C₂₀-aryl. Preferred organylaluminum compounds are the trialkylaluminum compounds, such as triethylaluminum, triisobutylaluminum (TIBA), tri-n-butylaluminum, triisopropylaluminum, tri-n-hexylaluminum. Use of triisobutylaluminum is particularly preferred. Other organylaluminum compounds which may be used are those produced by partial or complete hydrolysis, alcoholysis, aminolysis, or oxidation of alkyl- or arylaluminum compounds. Examples are diethylaluminum ethoxide, diisobutylaluminum ethoxide, diisobutyl (2,6-di-tert-butyl4-methylphenoxy)aluminum (CAS No. 56252-56-3), methylaluminoxane, isobutylated methylaluminoxane, isobutylaluminoxane, tetraisobutyldialuminoxane, and bis(diisobutyl)aluminum oxide.

As mentioned above, other suitable organylaluminum compounds are dialkylaluminum phenolates, e.g. diisobutylaluminum (2,6-di-tert-butyl4-methylphenolate). The dialkylaluminum phenolates represent a special case insofar as their amounts (molar ratios) used differ, as described above.

It is also possible to use various organylaluminum compounds together.

The organylaluminum compound is generally added to the reactor used to synthesize the rubber, this point being explained under stage 3).

Stage 3)

In the third stage of the process of the invention, styrene monomer is added to the solution obtained in stage 2).

Styrene monomers which may be used are the styrene monomers mentioned for stage 1), in particular styrene. As in stage 1), other comonomers may also be used in addition to the styrene monomer in stage 3). The proportion of comonomer is preferably from 0 to 50% by weight, based on the total amount of the monomers used in stage 3). Suitable comonomers are the comonomers mentioned for stage 1).

Stage 3) of the process preferably does not use any comonomers alongside styrene.

The styrene monomers (and, where appropriate, comonomers) added in stage 3) serve to dilute the rubber solution obtained in stage 2). The synthesis of the rubber (stage 1)) and the polymerization of the hard styrene matrix (stage 4), see below) usually take place in different reactors, and the rubber solution therefore has to be transported from the rubber-synthesis reactor into the reactor used to polymerize the hard matrix. The rubber solution, which is generally of high viscosity, can readily be conveyed by pumps after the dilution with styrene. Without dilution, the high viscosity of the rubber makes a simple pump-transfer process difficult or impossible, and more complicated means of conveying would be required.

The styrene monomer added in stage 3) is a diluent, and at the same time is the monomer for polymerizing the hard styrene matrix in the subsequent stage 4) of the process. A difference from the prior-art processes is therefore that the diluent is a reactant which is reacted to give the final product (and therefore does not have to be removed), and is not a solvent which would have to be separated from the final HIPS product.

Since the anionic polymerization reaction in stage 2) was stopped (frozen) by adding organylaluminum compound, and the dilution with styrene monomer does not alter the Al/Li molar ratio, the styrene monomer added in stage 3) does not polymerize at this stage, meaning that stage 3) of the process, like stage 2), is not a polymerization step.

Stage 3) gives a mixture (solution) of stopped rubber solution (rubber and inert solvent) and styrene monomer. This mixture is polymerized in the subsequent stage 4) to give the HIPS.

In one preferred embodiment, the solids content (SC) of the mixture obtained in stage 3) of the process is from 5 to 25% by weight, preferably from 14 to 18% by weight, and particularly preferably from 15 to 17% by weight, for example from about 16 to 16.5% by weight.

Stage 4)

Stage four of the process of the invention involves adding, to the mixture obtained in stage 3), organyllithium compound, or organyllithium compound and organylaluminum compound, their amounts being such that the aluminum/lithium molar ratio in the mixture is smaller than one, meaning that the Al/Li molar ratio in the resultant solution is <1 after addition of the organyllithium compound, or of the organyllithium compound and organylaluminum compound, and polymerizing the mixture anionically.

If the organylaluminum compound used comprises a dialkylaluminum phenolate, its amount added is such that the Al/Li molar ratio in the rubber solution is smaller than 0.5, meaning that the Al/Li molar ratio is <0.5 in the resultant solution after adding the dialkylaluminum phenolate.

The amount of organyllithium compound, or organyllithium compound and organylaluminum compound, added is preferably such that the Al/Li molar ratio is from 0.5 to 0.99, particularly preferably from 0.8 to 0.97. A small molar excess of lithium is therefore sufficient.

If the organylaluminum compound used comprises a dialkylaluminum phenolate, the amount added is preferably such that the Al/Li molar ratio is from 0.2 to 0.49.

Organyllithium compounds and organylaluminum compounds which may be used in stage 4) are the compounds mentioned above for stage 1) and stage 2). Different or identical organyllithium compounds may be used here in stage 1) and stage 4), and different or identical organylaluminum compounds may be used here in stage 2) and stage 4). It is preferable to use identical organyllithium compounds and, respectively, organylaluminum compounds.

It is likely that the polymerization reaction which was stopped (frozen) in stage 2) of the process by the molar excess of Al (Al/Li molar ratio >1) is now started again in stage 4) by the molar excess of Li, undergoing what amounts to a “thaw”. Addition of the organyllithium compound to give an Al/Li molar ratio <1 establishes an excess of the organyllithium initiator compound, and this reinitiates the anionic polymerization which had previously been stopped.

The principle of the above paragraph also applies to the special case of dialkylaluminum phenolates with an Al/Li molar ratio <0.5.

During the polymerization reinitiated in stage 4), it is probable that the monomers polymerize both on the living polymer chains of the rubber molecules and with themselves to form the hard matrix. It therefore appears that stage 4) involves not only polymerization of the matrix but also polymerization on the rubber, i.e. growth of the rubber. In particular in the case of styrene-butadiene block copolymer rubbers, it appears that the styrene blocks become enlarged in stage 4) by addition-polymerization of further styrene monomer molecules.

The process of the invention therefore probably shifts a portion of the synthesis of the rubber “backward” in time into the matrix-polymerization stage of the process. This accelerates the entire process, the rate-determining step of which is generally, as mentioned, the synthesis of the rubber.

The molar excess of lithium may be established by adding organyllithium compound alone, or by adding organyllithium compound and organylaluminum compound. The latter variant is preferred, because in some cases the addition of organyllithium compound alone can cause too rapid a rise in the reaction rate of the anionic polymerization, thus making control of the reaction difficult.

Organyllithium compound and organylaluminum compound may be added here separately from one another or—preferably—in the form of a mixture. The Al/Li molar ratio in this initiator/retarder mixture of organylaluminum compound and organyllithium compound is not critical and can vary within wide limits, for example Al/Li from 0.1 to 10. The only important factor is that the Al/Li molar ratio in the reaction mixture obtained in stage 4) of the process is smaller than one.

A distinction therefore has to be made between the non-critical Al/Li molar ratio in the initiator/retarder mixture and the important inventive Al/Li molar ratio in the reaction mixture in stage 4), comprising rubber, solvent, organyllithium initiator compound from stage 1), organylaluminum compound from stage 2), styrene monomer diluent from stage 3), and further organyllithium compound, or further organyllithium compound and further organylaluminum compound, from stage 4).

Since in stage 2) it was preferable to establish only a slight molar excess of Al, the addition of an initiator/retarder mixture with a very small Li excess in stage 4) is preferably sufficient to lower the Al/Li molar ratio in the reaction mixture to the target value (<1). Use may be made of an initiator/retarder mixture with an Al/Li molar ratio of about 0.9, for example.

The principle of the above paragraphs also applies for the special case of dialkylaluminum phenolates with an Al/Li molar ratio <0.5.

The organyllithium compounds and organylaluminum compounds used in stages 1), 2), and 4) of the process of the invention are used undiluted or (preferably) dissolved or suspended in a suitable solvent.

The preparation of the initiator/retarder mixture of stage 4) in particular preferably takes place with concomitant use of a solvent or suspension medium (depending on the solubility of the organyllithium compound or organylaluminum compound, the abbreviated term solvent being used below). Particularly suitable solvents are inert hydrocarbons, e.g. aliphatic, cycloaliphatic, or aromatic hydrocarbons, such as cyclohexane, methylcyclohexane, pentane, hexane, heptane, isooctane, benzene, toluene, xylene, ethylbenzene, decalin, or paraffin oil, or a mixture of these. Toluene is particularly preferred.

In one preferred embodiment, the organylaluminum compound of stage 2) is also used in solution in an inert hydrocarbon, e.g. toluene.

The anionic polymerization of the styrene in stage 4) in the presence of the rubber is particularly preferably undertaken in the presence of an initiator system obtainable by mixing the organyllithium compound with styrene and then adding the organylaluminum compound.

The anionic polymerization of stage 4) may in particular be undertaken in the presence of an initiator system obtainable by mixing sec-butyllithium and styrene and then adding triisobutylaluminum (TIBA).

It is likely that, starting from styrene and the organyllithium compound, an oligomeric polystyrene/lithium compound forms [polystyryl]⁺Li from a polystyryl anion and a lithium cation, and that the polymerization proceeds on the polystyryl anion.

The mixing of organyllithium compound and styrene preferably takes place with stirring at from 0 to 80° C., in particular from 20 to 50° C., particularly preferably from 20 to 30° C., with cooling if required. The organylaluminum compound is preferably not added until the resultant mixture has stood for a certain time: for example from 5 to 120 min, preferably from 10 to 30 min, after the mixing of styrene and organyllithium compound.

The initiator system may be permitted to age (stand) for a certain time after addition of the organylaluminum compound, e.g. at least 2 min, preferably at least 20 min. The aging or standing of the freshly prepared initiator system can in some cases be advantageous for reproducible use in the anionic polymerization. Experiments have shown that initiator components which are used separately from one another or are mixed only briefly prior to the initiation of tne polymerization in some cases give less reproducible polymerization conditions and polymer properties. The aging process observed is probably attributable to complex formation by the metal compounds, which proceeds more slowly than the mixing procedure.

As described, the molar excess of Li causes the polymerization to restart in stage 4), and the reaction mixture is polymerized to give the final impact-modified polystyrene (HIPS) product.

Depending on the amount of styrene monomer added in stage 3), the amount of styrene monomer present in stage 4) may be sufficient, or insufficient, to obtain the desired HIPS.

In the latter case, i.e. if a relatively low-rubber-content impact-modified polystyrene is desired, further styrene monomer may be added in stage 4), prior to or during the polymerization. This further addition of styrene is preferred.

If styrene monomer is added in the two stages 3) and 4), the proportion in stage 4) is generally from 20 to 60% by weight, preferably from 30 to 50% by weight, based on the total amount of styrene monomer added in stages 3) and 4).

The rubber content, based on the impact-modified polystyrene of the invention, is usually from 5 to 35% by weight, preferably from 14 to 27% by weight, and in particular from 18 to 23% by weight.

If, as is preferred, the rubbers used comprise butadiene-styrene copolymers—i.e. if the rubber contains not only butadiene but also styrene and/or another comonomer—the butadiene content of the impact-modified polystyrene of the invention is naturally smaller than the rubber content.

The butadiene content is preferably (whatever type of rubber is used) from 2 to 25% by weight, in particular from 8 to 16% by weight, and particularly preferably from 11 to 13% by weight, based on the impact-modified polystyrene of the invention.

It is preferable to add the styrene in stage 4) during the polymerization. For example, if the conduct of stage 4) of the reaction is continuous, the following materials may be metered continuously into the polymerization reactor:
the solution obtained in stage 3), comprising rubber, solvent, organylaluminum compound and organyllithium compound with Al/Li molar ratio >1 [>0.5], and styrene as diluent,
the organyllithium-compound, or the mixture of organyllithium compound and organylaluminum compound, to establish the Al/Li molar ratio <1 [<0.5], and
further styrene monomer.

The values in square brackets apply when the organylaluminum compound used comprises dialkylaluminum phenolates.

Further details

The polymerization of the diene monomers, or of the diene monomers and styrene monomers, to give the rubber in stage 1) may take place batchwise or continuously. It is preferable to operate batchwise in stage 1), for example in a stirred tank.

The polymerization of the styrene in the presence of the rubber in stage 4) may take place batchwise or preferably continuously in stirred tanks, circulating reactors, tubular reactors, tower reactors, or rotating disk reactors, as described in WO 98/07766. The polymerization is preferably carried out continuously in a reactor arrangement composed of at least one back-mixing reactor (e.g. stirred tank) and of at least one non-back-mixing reactor (e.g. tower reactor).

Conversion, based on the styrene of the hard matrix, is generally above 90%, preferably above 99%. In principle, the process may also give complete conversion.

Once the polymerization of the styrene monomer has ended (end of stage 4)), the reaction is preferably ended by using a protic substance. Examples of suitable protic substances are alcohols, such as isopropanol, phenols; water; or acids, such as aqueous carbon dioxide solution, or carboxylic acids, such as ethylhexanoic acid.

The inert solvents and other polymerization auxiliaries used concomitantly during the synthesis of the rubber are generally subsequently removed. This takes place in a manner known per se, e.g. by means of devolatilization in a vented extruder, or by means of other commonly used apparatus, such as partial evaporators or vacuum vessels. In particular, a combination of partial evaporator and vacuum vessel may be used to remove the solvent and the auxiliaries.

The content of styrene monomers in the impact-modified polystyrene of the invention is generally not more than 50 ppm, preferably not more than 10 ppm, and the content of styrene dimers and styrene trimers is generally not more than 500 ppm, preferably not more than 200 ppm, particularly preferably less than 100 ppm. The content of ethylbenzene in the impact-modified polystyrene is preferably below 5 ppm.

It can be advantageous to use an appropriate temperature profile and/or addition of peroxides, in particular those with a high decomposition temperature, such as dicumyl peroxide, to crosslink the rubber particles. The peroxides here are added after the polymerization has ended and, where appropriate, after addition of the chain terminator, and prior to devolatilization. However, it is preferable to crosslink the soft phase thermally at a temperature in the range from 200 to 300° C. after the polymerization.

The impact-modified polystyrene of the invention may be used undiluted. However, it may also be blended with other thermoplastic polymers, e.g. with other polystryrenes, in particular with polystyrenes whose molecular weight is conventional, or particularly high, or particularly low, and which have been polymerized by an anionic or free-radical route, and are rubber-free or rubber-containing (=impact-modified).

To increase tensile strain at break, from 0.1 to 10% by weight, preferably from 0.5 to 5% by weight, of mineral oil (white oil), based on the impact-modified polystyrene, may be added to the impact-modified polystyrene of the invention.

The polymers may also comprise conventional amounts of other conventional additives and processing auxiliaries, e.g. lubricants, mold-release agents, colorants, e.g. pigments or dyes, flame retardants, antioxidants, light stabilizers, fibrous or pulverulent fillers, fibrous or pulverulent reinforcing agents, or antistatic agents, or else other additives, or a mixture of these. In relation to these additives see, for example, Gachter, Muller, Plastics Additives, 4th edition, Hanser Verlag 1993, Reprint Nov. 1996.

Mixing processes known per se may be used to blend the impact-modified polystyrenes of the invention with the other polymers and with the additives or processing auxiliaries, examples being melting in an extruder, Banbury mixer, or kneader, or on a roll mill or calender. However, the components may also be “cold” mixed, the mixture composed of powder or of pellets not being melted and homogenized until processing begins.

The impact-modified polystyrenes may be used to produce moldings of any type (including semifinished products, unsupported films, supported films, and foams).

The invention therefore also provides the use of the impact-modified polystyrenes of the invention to produce moldings, films, fibers, or foams, and provides the moldings, films, fibers, or foams obtainable from the impact-modified polystyrenes.

The polymers of the invention have low content of residual monomers and residual oligomers.

This advantage is particularly important in the case of styrene-containing polymers, because the low content of residual styrene monomers and styrene oligomers makes subsequent devolatilization superfluous, for example devolatilization in a vented extruder, associated with relatively high costs and disadvantageous thermal degradation of the polymer (depolymerization).

The process of the invention requires no coupling agents or terminators during the synthesis of the rubber. In addition, the rubber solution has a relatively high solids content. Each of the two features represents a considerable economic advantage: the synthesis of the rubber is faster, and there is therefore an improvement in the capacity of the entire process (synthesis of the rubber plus polymerization of the hard styrene matrix). In addition, the process of the invention provides controlled retardation of the polymerization of the hard matrix.

Finally, the solids content of the resultant HIPS solution is higher than in prior-art processes, and this makes separation of the solvent easier.

The impact-modified polystyrene of the invention has a high level of mechanical and thermal properties. The advantages of the process are not achieved at the cost of product properties.

### EXAMPLES

The following compounds were used. “Purified” here means that the materials were dried and purified using aluminoxane:
styrene, purified, from BASF,
butadiene, purified, from BASF,
sec-butyllithium (s-Buli) in the form of 12% strength by weight solution in cyclohexane, ready-to-use solution from Chemmetall,
triisobutylaluminum (TIBA) in the form of 20% strength by weight solution in toluene, ready-to-use solution from Crompton,
toluene, purified, from BASF.

An additive mixture was also used, composed of
a) 2% by weight of n-octadecyl 3-(3,5-di-tert-butyl4-hydroxyphenyl)propionate;

Irganox® 1076 from Ciba Specialty Chemicals was used
b) 2% by weight of water, and
c) 96% by weight of white oil; Winok® 70 mineral oil from Wintershall was used.

1. Preparation of initiator/retarder mixture

5 210 g of toluene formed an initial charge at 25° C. in a 15 1 stirred tank, and 500 g of styrene and 518 g of the 12% strength by weight solution of sec-butyllithium in cyclohexane were added, with stirring. After 15 min, 863 g of the 20% strength by weight solution of triisobutylaluminum in toluene were added to the mixture, which was then cooled to 40° C. The Al/Li molar ratio was 0.9.

2. Preparation of rubber solutions and polymerization of hard matrix

The following rubbers were first prepared, and then polymerized with styrene to give the HIPS. The numerals give the block lengths in kg/mol (molar masses of the individual blocks):

Examples 1a-c: 160/22 and 165/23 butadiene-styrene two-block copolymers

Example 2: 22/165/25 styrene-butadiene-styrene three-block copolymer.

Example 3: 160 homopolybutadiene.

In the general specification below, the variables A, B, C, etc. are the parameters which were varied and, respectively, the properties obtained. The individual values are given in table 1.

A kg of toluene formed an initial charge in a batchwise-operated 1 500 I stirred tank, and were treated, with stirring, with monomer portion M1. After the temperature of the mixture had been controlled to 50° C., B ml of the 12% strength by weight solution of sec-butyllithium in cyclohexane were added. After 10 min, the temperature of the mixture was controlled to 60° C., and monomer portion M2 was added. After a further 20 min, evaporative cooling was used to cool the mixture to 60° C., and monomer portion M3 was added. The same procedure was used with monomer portions M4 to M7: after each addition a standing time of from 20 to 30 min, cooling to 60° C., next addition.

30 min after the final addition of monomer, the mixture was again cooled to 60° C., and C ml of the 20% strength by weight solution of triisobutylaluminum in toluene were added. This gave a rubber solution with an Al/Li molar ratio of D and a solids content 1 of E% by weight.

The temperatures mentioned were internal reactor temperatures.

This solution was then diluted using F kg of monomeric styrene, giving a mixture with a solids content of 2 of G% by weight. The mixture thus comprised the rounded proportions of rubber, toluene, and styrene given under H.

Gel permeation chromatography was used to study the rubber polymer (GPC in tetrahydrofuran, calibration using polybutadiene and, respectively, polystyrene standards). In all cases the distribution was monomodal, and in all examples the residual content of butadiene monomer was less than 10 ppm. Under J, the table gives the block structure of the rubbers, and the block lengths in kg/mol (molar masses).

The butadiene content of the rubber was given by ¹H nuclear resonance spectra as K% in the 1,2-vinyl form.

The subsequent polymeerization of the hard styrene matrix was carried out continuously in a jacketed 50 I stirred tank with a standard anchor stirrer. The reactor was designed for an absolute pressure of 25 bar and had temperature control, using a heating medium and evaporative cooling for isothermic conduct of a reaction.

L kg/h of styrene, N kg/h of the above rubber solution, and P g/h of the initiator/retarder mixture (see above under No. 1) were metered continuously into the stirred tank, with stirring at 115 rpm, and held at a constant external reactor temperature of 130° C. At the outlet from the stirred vessel, conversion was from 35 to 45%, and the Al/Li molar ratio in the reaction mixture was Q.

The mixture was passed to a stirred 29 1 tower reactor provided with two heating zones of equal size (first zone 110C, second zone 160° C. internal temperature).

The discharge from the tower reactor had a solids content 3 of R% by weight. It was continuously treated with 600 g/h of the additive solution, and then passed through a mixer, and finally conducted through a tube section heated to 250° C. The mixture was then passed by way of a pressure-regulator valve into a partial evaporator operated at 300° C., and depressurized into a vacuum vessel operated at 10 mbar absolute pressure and 280° C. The polymer melt was discharged using a conveying screw, and pelletized. Conversion was quantitative.

Residual monomer content of the impact-modified polystyrene was determined, for styrene and ethylbenzene, in the usual way by means of gas chromatography. In all examples it was below

5 ppm of styrene and below 5 ppm of ethylbenzene.

TABLE 1
Individual values for variables and properties

| Example | | | |
|---|---|---|---|
| 1a | 1b∥1c | 2 | 3 |

Synthesis of rubber

| | | | | |
|---|---|---|---|---|
| A Amount of toluene [kg] | 321 | 256 | 321 | 321 |
| M1 Monomer portion 1 [kg] | 18 | 18 | 15.9 | 36 |
| | St | St | St | Bu |
| B Amount of s-BuLi [ml] | 560 | 560 | 500 | 650 |
| M2 Monomer portion 2 [kg] | 26 | 26 | 25 | 29.4 |
| | Bu | Bu | Bu | Bu |
| M3 Monomer portion 3 [kg] | 31.4 | 31.4 | 20 | 22.7 |
| | Bu | Bu | Bu | Bu |
| M4 Monomer portion 4 [kg] | 20 | 20 | 20 | 22.7 |
| | Bu | Bu | Bu | Bu |
| M5 Monomer portion 5 [kg] | 20 | 20 | 20 | 22.6 |
| | Bu | Bu | Bu | Bu³⁾ |
| M6 Monomer portion 6 [kg] | 18 | 18 | 16.7 | — |
| | Bu⁴⁾ | Bu⁴⁾ | Bu | |
| M7 Monomer portion 7 [kg] | — | — | 15.9 | — |
| | | | St²⁾ | |
| C Amount of TIBA [ml] | 1 000 | 1 000 | 900 | 1 150 |
| D Al/Li molar ratio | 1.12 | 1.12 | 1.13 | 1.12 |
| E Solids content 1 [% by weight] | 30.3 | 35.2 | 30.1 | 30.0 |
| F Amount of styrene [kg] | 379 | 443 | 379 | 379 |
| G Solids content 2 [by weight %] | 16.2 | 16.2 | 16.1 | 16.0 |
| H Proportions [% by weight] rubber/toluene/St | 16/49/35 | 16/31/53 | 14/49/35 | 16/49/35 |
| J Block structure | B-S | B-S | S-B-S | B⁵⁾ |
| block lengths [kg/mol] | 160-22 | 165-23 | 22-165-25 | 160 |
| K 1,2-Vinyl form[%] | 11.5 | 11.8 | 11.2 | 11.0 |

Polymerization of hard matrix

| | | | | |
|---|---|---|---|---|
| L Styrene feed [kg/h] | 3.85 | 3.85 | 3.62 | 5.53 |
| N Rubber solution feed [kg/h] | 12.2 | 12.2 | 12.45 | 10.55 |
| P Init./retard. mixture feed [g/h] | 350 | 350∥500¹⁾ | 350 | 350 |
| Q Al/Li molar ratio | 0.94 | 0.94∥0.93 | 0.95 | 0.94 |
| R Solids content 3 [% by weight] | 71 | 75 | 70 | 74 |

Key to table 1
St monomeric styrene
Bu monomeric butadiene
— no addition
S styrene block
B butadiene block
¹⁾Example 1b∥example 1c. Ex. 1c is similar to ex. 1b, but in ex. 1c 500 g/h of initiator/retarder mixture were used instead of 350 g/h.
²⁾Styrene portion M7 was added only 10 min after the final butadiene portion M6.
³⁾Butadiene portion M5 was added only 10 min after the previous butadiene portion M4.
⁴⁾Butadiene portion M6 was added only 10 min after the previous butadiene portion M5.
⁵⁾Homopolybutadiene

1Example 1b || example 1c. Ex. 1c is similar to ex. 1b, but in ex. 1c 500 g/h of initiator/retarder mixture were used instead of 350 g/h.
2) Styrene portion M7 was added only 10 min after the final butadiene portion M6.
3) Butadiene portion M5 was added only 10 min after the previous butadiene portion M4.
4) Butadiene portion M6 was added only 10 min after the previous butadiene portion M5.
5) Homopolybutadiene.

3. Properties of impact-modified polystyrene

The resultant impact-modified polystyrene was pelletized and dried. The pellets were injection molded at a melt temperature of 220° C. and at a mold surface temperature of 45° C. to give the appropriate test specimens.

The following properties were determined:

Vicat B heat distortion temperature: for this, Vicat softening point VSP was determined, method B50 (force 50 N, heating rate 50° C./h) to EN ISO 306, on test specimens produced to EN ISO 3167.

Melt volume flow rate MVR: determined on pellets to EN ISO 1133 at 200° C test temperature and 5 kg nominal load.

Charpy notched impact strength aK: determined to EN ISO 179/1eA (=test specimen type 1, impact direction e short edge, notch type A V-shaped) with milled notch, at 23° C.

Yield stress as and nominal tensile strain at break ER: each determined in the tensile test to EN ISO 527 (DIN EN ISO 527-1 and 527-2) at 23° C. Table 2 gives the results.

TABLE 2
Properties of impact-modified polystyrene

| | Example | | | | |
|---|---|---|---|---|---|
| | 1a | 1b | 1c | 2 | 3 |
| Vicat B heat distortion | 90.5 | 91.2 | 89.0 | 90.1 | 90.3 |
| temperature [° C.] | | | | | |
| MVR flow rate, 200° C., | 6.2 | 4.7 | 9.6 | 5.1 | 4.8 |
| 5 kg [cm³/10 min] | | | | | |
| Charpy notched impact | 18.9 | 20.2 | 17.6 | 21.2 | 15.6 |
| strength a_{K}, 23° C. [kJ/m²] | | | | | |
| Yield stress σ_{S}, 23° C. [MPa] | 29.8 | 30.2 | 32.1 | 31.3 | 31.2 |
| Tensile strain at | 35 | 36 | 29 | 42 | 33 |
| break ε_{R}, 23° C. [%] | | | | | |

The examples show that the process of the invention can prepare impact-modified polystyrenes with good thermal and mechanical properties.

We claim:

1. A process for preparing impact-modified polystyrene by anionic polymerization, which comprises
1) preparing a rubber solution from diene monomers, or from diene monomers and styrene monomers, by anionic polymerization, using an organyllithium compound as initiator, and with concomitant use of a solvent,
2) adding, to the resultant rubber solution, an organylaluminum compound, its amount being such that the aluminum/lithium molar ratio in the rubber solution is greater than 1 or, if the organylaluminum compound used comprises a dialkylaluminum phenolate, is greater than 0.5,
3) adding styrene monomer to the resultant solution, and
4) adding, to the resultant mixture, organyllithium compound, or organyllithium compound and organylaluminum compound, the amount being such that the aluminum/lithium molar ratio in the mixture is smaller than 1 or, if the organylaluminum compound used comprises a dialkylaluminum phenolate, is smaller than 0.5, and polymerizing the mixture anionically.

2. The process as claimed in claim 1, wherein, during the preparation of the rubber solution in stage 1), no concomitant use is made of compounds which have a retarding action on the anionic polymerization.

3. The process as claimed in claim 1, wherein the diene monomer used comprises butadiene and the styrene monomer used comprises styrene.

4. The process as claimed in claim 1, wherein the rubber has been selected from polybutadiene and styrene-butadiene block polymers.

5. The process as claimed in claim 1, wherein the styrene-butadiene block copolymer rubber comprises at least one butadiene block with a weight-average molar mass of from 50,000 to 250,000 g/mol.

6. The process as claimed in claim 1, wherein the butadiene content of the rubber is from 70 to 100% by weight.

7. The process as claimed claim 1, wherein the solids content of the rubber solution obtained in stage 1) is from 20 to 40% by weight.

8. The process as claimed in claim 1, wherein the solids content of the mixture obtained in stage 3) is from 5 to 25% by weight.

9. The process as claimed in claim 1, wherein the aluminum/lithium molar ratio of the solution obtained in stage 2) is from 1.01 to 10 or, if the organylaluminum compound used comprises a dialkylaluminum phenolate, is from 0.51 to 10.

10. The process as claimed in claim 1, wherein the aluminum/lithium molar ratio of the mixture obtained in stage 4) is from 0.5 to 0.99 or, if the organylaluminum compound used comprises a dialkylaluminum phenolate, is from 0.2 to 0.49.

11. The process as claimed in claim 1, wherein further styrene monomer is added in stage 4) prior to or during the polymerization.

12. The process as claimed in claim 2, wherein the diene monomer used comprises butadiene and the styrene monomer used comprises stvrene.

13. The process as claimed in claim 2, wherein the rubber has been selected from polybutadiene and styrene-butadiene block polymers.

14. The process as claimed in claim 3, wherein the rubber has been selected from polybutadiene and styrene-butadiene block polymers.

15. The process as claimed in claim 2, wherein the styrene-butadiene block copolymer rubber comprises at least one butadiene block with a weight-average molar mass of from 50,000 to 250,000 g/mol.

16. The process as claimed in claim 3, wherein the styrene-butadiene block copolymer rubber comprises at least one butadiene block with a weight-average molar mass of from 50,000 to 250,000 g/mol.

17. The process as claimed in claim 4, wherein the styrene-butadiene block copolymer rubber comprises at least one butadiene block with a weight-average molar mass of from 50,000 to 250.000 g/mol.

18. The process as claimed in claim 2, wherein the butadiene content of the rubber is from 70 to 100% by weight.

19. The process as claimed in claim 3, wherein the butadiene content of the rubber is from 70 to 100% by weight.

20. The process as claimed in claim 4, wherein the butadiene content of the rubber is from 70 to 100% by weight.
